(19) United States
(12) Patent Application Publication
(10) Pub. No.: US 2009/0313155 A1
(43) Pub. Date: Dec. 17, 2009

(54) DATA CHARGING SYSTEM, CONTENT GENERATOR, DATA CHARGING APPARATUS, AND DATA CHARGING METHOD

(75) Inventors: Satoru Sawada, Kanagawa-ken (JP); Hirokazu Yasumuro, Kanagawa-ken (JP)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/544,492

(22) Filed: Aug. 20, 2009

Related U.S. Application Data
(62) Division of application No. 09/457,842, filed on Dec. 9, 1999.

(30) Foreign Application Priority Data
Dec. 11, 1999 (JP) 10-352399

(51) Int. Cl. G06Q 50/00; G06Q 20/00; G06F 21/24

(52) U.S. Cl. 705/34; 726/30

(57) ABSTRACT

The present invention is directed to a system and method of charging the user for his/her use of digital contents in an easy and reliable manner. More particularly, the present invention provides a server machine 16 generates digital contents and supplies them to a client machine 10. When it receives payment for the use of the contents, it writes charging data containing recognition data, count data, etc. into an IC card, which is inserted into the card reader of the client machine 10. The client machine 10 compares recognition data or the like extracted from the IC card with those from the digital contents. When a match is found, the client machine 10 embeds or detects a digital watermark in the digital contents. In this way, the user is charged for the use of digital contents on a pay-per-use basis according to the usage count, usage time, etc.

### CROSS REFERENCE TO RELATED APPLICATION

This application is a divisional of U.S. patent application Ser. No. 09/457,842, filed Dec. 9, 1999 the disclosure of which is incorporated herein by reference in its entirety

### BACKGROUND OF THE INVENTION

1. Technical Field

The present invention relates to a data charging system, content generator, data charging apparatus, and data charging method which provide data and programs to users via a network or recording medium and make a charge according to the amount of use.

More particularly, the present invention relates to a data charging system, content generator, data charging apparatus, and data charging method which apply a marking technique called data hiding or the like to charging for the use of data and programs.

2. Prior Art

Accounting methods are considered which involve distributing digital contents (also referred to simply as contents) such as software and programs to a user and charging when the user uses any of the digital contents.

For example, JP Published Examined Patent Application No. 6-95302 (Reference 1) discloses an accounting method in which one recording medium containing chargeable software and a usage charge list is distributed to the user and the user's data processing system processes his/her account by using that information.

Also under consideration are accounting methods which combine the above-mentioned accounting method with a recording medium capable of storing data on a built-in memory such as an IC card.

For example, JP Published Examined Patent Application No. 6-19707 (Reference 2) discloses an accounting method which employs such an IC card.

Also, a marking technique which involves embedding a visible or invisible data (a mark) called a digital watermark or the like has been developed to indicate the copyright holder of digital contents such as image data clearly or prevent their illegal use.

For example, “correct digital watermarking of images” (Reference 3: U.S. Pat. No. 5,530,759) and “Method and apparatus for reducing quantization artifacts in a hierarchical image storage and retrieval system” (Reference 4: U.S. Pat. No. 5,568,570) disclose marking techniques which involve embedding additional visible information in digital contents.

Besides, “Scrambling Digital Image Data for Copyright Protection” (Reference 5: SCIS96-9A) discloses a scrambling technique for protecting digital contents from unauthorized use and “NICKEI ELECTRONICS, No. 694, 7-14 (pp. 17-18), 1997” (Reference 6) discloses an image delivery system which combines this scrambling technique with a watermarking technique for embedding additional invisible information in digital contents.

The November 1998 issue of “Nikkei Internet Technology” (Reference 7) carries an explanatory article about digital watermarking.

Products, such as IBM DataHiding Plug-in for Adobe Photoshop for Macintosh, which employ such digital watermarking technology are on the market.

However, since the accounting methods disclosed in References 1 and 2 need user-specific information for accounting, it is difficult to use these methods in combination with a recording medium called a smart card which allows an IC card to be used in a manner similar to currencies.

Also, with the marking techniques disclosed in References 3 to 6, it will be possible to ask the user to pay prices for the use of digital contents in exchange for deletion of the mark in digital contents.

According to such a method, however, the user have to select whether to pay the full amount or pay no price depending on whether he/she uses digital contents or not. There is no way to charge the user on a pay-per-use basis according to the extent of use (usage time, usage count, amount of data used, etc.: hereafter referred to simply as usage).

The present invention has been made to solve the conventional problems described above. Consequently, an object of the present invention is to provide a data charging system, content generator, data charging apparatus, and data charging method capable of charging the user for his/her use of digital contents in an easy and reliable manner by using a smart card.

Another object of the present invention is to provide a data charging system, content generator, data charging apparatus, and data charging method capable of charging the user for his/her use of digital contents on a pay-per-use basis.

Still another object of the present invention is to provide a data charging system, content generator, data charging apparatus, and data charging method capable of charging the user for his/her use of digital contents in an easy and reliable manner while preventing unauthorized use of digital contents by means for digital watermarking or the like.

### SUMMARY OF THE INVENTION

To attain the above-mentioned objects, the present invention provides a data charging system which comprises a content generator for generating contents containing object data, a recording medium for recording the charging data used for charging for said object data and the recognition data used for recognition of the object data, and a data charging apparatus for charging for the use of said object data by using said charging data and said recognition data recorded, wherein said data charging apparatus comprises a data reading logic for reading said recognition data and said charging data from said recording medium, a separator for separating said object data from said contents, an recognition logic for recognizing said separated object data by using said recognition data read out, an accounting logic for charging for the use of said recognized object data by using said charging data read out, and a writing logic for writing, as said charging data, the results of charging for the use of said recognized object data into said recording medium.

### BRIEF DESCRIPTION OF THE DRAWINGS

Preferred embodiments of the present invention will now be described, by way of example only, with reference to the accompanying drawings in which:

FIG. 1 illustrates the configuration of the data charging system according to the present invention;

FIG. 2 illustrates the configuration of the client machines and server machines shown in FIG. 1;

FIG. 3 shows the configuration of the content generation program which runs on the server machine of FIGS. 1 and 2;

FIG. 4 shows the watermark information added to contents by the content generation program of FIGS. 1 and 2;

FIG. 5 shows the charging data recorded on the IC card shown in FIG. 1;

FIG. 6 shows the configuration of the watermarking/accounting program which runs on the client machine of FIGS. 1 and 2;

FIG. 7 shows the configuration of the accounting engine shown in FIG. 6;

FIG. 8 shows the content information output by the digital-watermarking engine of FIG. 6 to the accounting engine;

FIG. 9 is a flowchart showing the watermarking process and detection/removal process (digital-watermarking process: S10) performed by the digital-content receiving module and digital-watermarking engine of FIG. 6;

FIG. 10 is a flowchart showing the watermarking process (S40 in FIG. 9) of digital contents containing static image data;

FIG. 11 is a flowchart showing the watermarking process (S42 in FIG. 9) of digital contents containing audio data;

FIG. 12 is a flowchart showing the watermarking process (S44 in FIG. 9) of digital contents containing dynamic image data;

FIG. 13 is a flowchart showing the watermarking process (S46 in FIG. 9) of digital contents containing text data;

FIG. 14 is a flowchart showing the process (S30 in FIG. 9) of generating content information (FIG. 8) from digital contents containing static image data;

FIG. 15 is a flowchart showing the process (S32 in FIG. 9) of generating content information (FIG. 8) from digital contents containing audio or dynamic image data;

FIG. 16 is a flowchart showing the process (S34 in FIG. 9) of generating content information (FIG. 8) from digital contents containing text data;

FIG. 17 is a flowchart of the accounting process (S20) shown in FIG. 9; and

FIG. 18 is a flowchart of the billing process (S24) shown in FIG. 17.

### DETAILED DESCRIPTION OF THE PREFERRED

### Embodiments of the Invention

The content generator according to the present invention embeds digital watermarks in object data and generates contents in a data charging system which records, on a recording medium, the charging data used for charging for object data contained in said contents and the recognition data used for recognizing the object data and charges only for the use of the object data embedded with said digital watermarks by using said charging data and said recognition data recorded.

In a data charging system which records, on a recording medium, the charging data used for charging for object data contained in said contents and the recognition data used for recognizing the object data and charges for the use of said object data by using said charging data and said recognition data recorded; the data charging apparatus according to the present invention comprises a data reading logic for reading said recognition data and said charging data from said recording medium, a separator for separating said object data from said contents, an recognition logic for recognizing said separated object data by using said recognition data read out, an accounting logic for charging for the use of said recognized object data by using said charging data read out, and a writing logic for writing, as said charging data, the results of charging for the use of said recognized object data into said recording medium.

Preferably, said contents comprise said object data and said recognition data for recognizing this object data, said separator separates said object data and said recognition data from said contents, said recognition logic recognizes said object data, based on said recognition data separated from said contents and on said recognition data read out from said recording medium, and said accounting logic charges for said object data by using said charging data read out.

Preferably, said data charging apparatus further comprises a watermarking logic for embedding digital watermarks in said object data separated from said contents, wherein said separator separates said object data and said recognition data from said contents, said recognition logic recognizes said object data, based on said recognition data separated from said contents and on said recognition data read out from said recording medium, and said accounting logic charges for said object data embedded with said digital watermarks.

Preferably, a digital watermark is embedded in said object data, and the data charging apparatus further comprises a means for detecting if said object data is embedded with said digital watermark, wherein said separator separates said object data and said recognition data from said contents, said recognition logic recognizes said object data based on said recognition data separated from said contents and on said recognition data read out from said recording medium, and said accounting logic charges for said object data only if said object data is found to be embedded with said digital watermark.

Preferably said charging data recorded on said recording medium contains at least payment data which indicates the payment made in advance for the use of said object data, and said accounting logic charges for the use of said object data within the limits of the amount indicated by said payment data contained in said charging data.

Preferably, said charging data recorded on said recording medium further contains unit price data representing the accounting unit for the use of said object data and the price corresponding to the accounting unit, the data charging apparatus comprises an accounting unit detection logic for detecting unit accounting amount data which represents the amount of said accounting unit for the object data separated from said contents, and said accounting logic charges prices for the use of said object data within the limits of the amount indicated by said payment data, based on said unit price data contained in said charging data read out and on the unit accounting amount data detected.

Preferably, said charging data recorded on said recording medium further contains unit price data representing the accounting unit for the use of said object data and the price corresponding to the accounting unit as well as accounting range data which represents the range of one billing, and the data charging apparatus comprises an accounting unit detection logic for detecting unit accounting amount data which represents the amount of said accounting unit for the object data separated from said contents, and said accounting logic charges a price each time for the use of said object data within the limits of the amount indicated by said payment data, based on said unit price data contained in said charging data read out and on the unit accounting amount data detected.

The first content generator according to the present invention is made available to the user for pay and copyright information or the like are embedded as visible or invisible digital watermarks in the object data [for example, static or dynamic images or home or business programs (data program)] to be charged for.

Furthermore, the first content generator generates digital contents which contain data programs embedded with digital watermarks as well as identifiers/identification numbers (recognition data) for recognition of the data programs, and delivers them to users' computers via recording media, such as CD-ROMs or magneto-optical disks (MO), or a network.

The second content generator according to the present invention generates digital contents which contain said object data and said recognition data without embedding digital watermarks and delivers them to users' computers via recording media or a network.

The recording medium, for example, is an IC card (smart card) which comprises nonvolatile memory such as flash memory as well as I/O contacts for exchanging data between this memory and external apparatus, stores the charging data necessary for charging the user for his/her use of digital contents, and supplies this data to outside.

The charging data stored on the IC card (recording medium) contains, for example, recognition data, unit price data, payment data, and accounting range data.

The recognition data, for example, is an identifier unique to each data program (object data) to be charged for, and corresponds to the above-mentioned recognition data added to data programs by the content generator.

The unit price data represents, for example, the unit of measurement of data program usage (chargeable amount) and the price (in terms of counts) to be charged (unit amount of accounting) for certain units of data program usage.

The payment data represents, for example, the balance in the price or amount (count) the user paid for the use in advance to the owner of the data program.

The accounting range data represents, for example, the one-time usage of a data program that causes the payment data to be reduced in the accounting process or the upper limit of one-time usage (upper or lower limit of accounting).

The first data charging apparatus according to the present invention extracts a data program and recognition data from digital contents which are generated by the first content generator according to the present invention and which contain recognition data as well as data programs embedded with digital watermarks representing copyright information or the like.

Besides, the first data charging apparatus detects if the extracted data program is embedded with a digital watermark and makes the extracted data program available for use to the user only if the data program is embedded with a digital watermark.

Furthermore, the first data charging apparatus charges the user for his/her use of the data program on a pay-per-use basis by using the extracted recognition data and the charging data read out from the IC card (recording medium) only if the object data is found to be embedded with the digital watermark.

The second data charging apparatus according to the present invention extracts a data program and recognition data from digital contents which are generated by the second content generator according to the present invention and which contain recognition data as well as data programs not embedded with a digital watermark.

Besides, the second data charging apparatus makes the extracted data program available to the user after embedding a digital watermark in it.

Furthermore, the second data charging apparatus charges the user for his/her use of the data program embedded with digital watermarks on a pay-per-use basis by using the extracted recognition data and the charging data read out from the IC card (recording medium).

In the first and second data charging apparatus according to the present invention, the data reading and writing means are, for example, an apparatus called an IC card reader.

The data reading means reads out the charging data recorded on an IC card (recording medium) and outputs it to another component (accounting means or the like).

The data writing means records the charging data (payment data) inputted from another component (accounting means or the like) to an IC card (recording medium).

In the first and second data charging apparatus, the separator separates data programs embedded with digital watermarks or not embedded with digital watermarks as well as recognition data from the digital contents which are generated by the content generator and supplied to users' computers via a CD-ROM or the like.

In the first and second data charging apparatus, the recognition means compares the recognition data read out, for example, from the IC card (recording medium) with the recognition data separated from the contents read out from the CD-ROM or the like, and decides that the data program separated from the contents is the data program recognized by these recognition data and that the data program is fit for accounting by means for the IC card inserted in the IC card reader (data reading and writing means) if the two kinds of recognition data match.

In the first data charging apparatus, the means for detecting a digital water mark determines if the separated data program is embedded with a digital watermark and makes the data program available to the user only if the data program is embedded with a digital watermark.

In the second data charging apparatus, the means for embedding a digital watermark makes the separated data program available to the user after embedding a digital watermark in it.

Thus, in both the first and second data charging apparatus, the data program provided to the user is embedded with a digital watermark, which protects the copyright of the data program.

In the first and second data charging apparatus, for example, the accounting means charges for the use of a data program within the limits of the amount (count) indicated by the payment data contained in the charging data read out.

In other words, the accounting means measures the usage (usage count, data volume, processing time, etc.) of the data program by the user at the time, based on the unit accounting amount data (chargeable amount).

Then, the accounting means limits the measured usage within the range of the usage indicated by the accounting range data (upper and lower limits of accounting) and calculates the price (count) to be charged for the usage at the time by using the unit price data (unit amount of accounting).

Furthermore, the accounting means subtracts the price (count) to be charged according to the usage at the time from the price (count) indicated by the payment data, and records the new payment data (count) resulting from the subtraction into the IC card (recording medium) via the data writing means.

The data charging method according to the present invention, for generating contents which contain object data and recognition data used for the recognition of this object data, recording the charging data used to charge for said object data and the recognition data used for recognition of the object data, and charging for the use of said object data by using said charging data and said recognition data recorded, comprises the steps of reading said recognition data and said charging data from said recording medium, separating said object data from said contents, recognizing said separated object data by means for said recognition data read out, charging for the use of said recognized object data by means for said charging data read out, and writing, as said charging data, the results of charging for the use of said recognized object data into said recording medium.

Preferably, said contents are generated by embedding said object data with recognition data unique to this object data in the form of visible or invisible digital watermarks, said recognition data embedded in said contents as said digital watermarks are separated together with said object data from said contents, and said object data is recognized based on said recognition data separated from said contents and on said recognition data read out from said recording medium.

In a content generator of a data charging system which records, on a recording medium, the charging data used for charging for the object data contained in contents and the recognition data used for recognition of the object data, and charges for the use of said object data by using said charging data and said recognition data recorded; the first recording medium according to the present invention records a program which makes a computer execute the step of embedding said object data with recognition data used for recognition of this object data in the form of visible or invisible digital watermarks and the step of generating contents.

In a data charging apparatus of a data charging system which records, on a recording medium, the charging data used for charging for the object data contained in contents and the recognition data used for recognition of the object data, and charges for the use of said object data by using said charging data and said recognition data recorded; the second recording medium according to the present invention records a program which makes a computer execute the steps of reading said recognition data and said charging data from the recording medium, separating said object data from said contents, recognizing said separated object data by means for said recognition data read out, charging for the use of said recognized object data by means for said charging data read out, and writing, as said charging data, the results of charging for the use of said recognized object data into the recording medium.

Before describing the data charging system according to the present invention in detail, an overview will be provided to illustrate the marking of data programs by means for so-called digital watermarking.

With the development of network infrastructures including the Internet, the flow of digital information is growing remarkably in the world. Since digital information lends itself easily to duplication and fabrication, it is prone to illegal copying, which makes copyright protection an important issue.

Cryptographic techniques which excel in stability and security during data transfer are used for protection of digital information. Once the receiver of encoded information has decoded it, however, it is not possible to prevent duplication of the decoded information.

In view of this, to put a check on illegal copying and distribution of digital images, a variety of methods have been devised for embedding visible or invisible data (so-called digital watermarks) inseparably in image data.

The marking technology (also known as data hiding or the like) by the use of such digital watermarks is designed to prevent the digital watermarks from losing effect even if the information embedded with the digital watermarks are modified, while preserving the quality of image data or the like.

This marking technology has various applications including copyright protection and can be applied to a variety of digital information such as static images, dynamic images, and audio.

With this marking technology, data available for various processes can also be embedded in digital information together with digital watermarks.

Besides, this marking technology makes it possible to supply digital contents with embedded information separated to the users who have paid due prices, or supply the separated information to programs which run various processes.

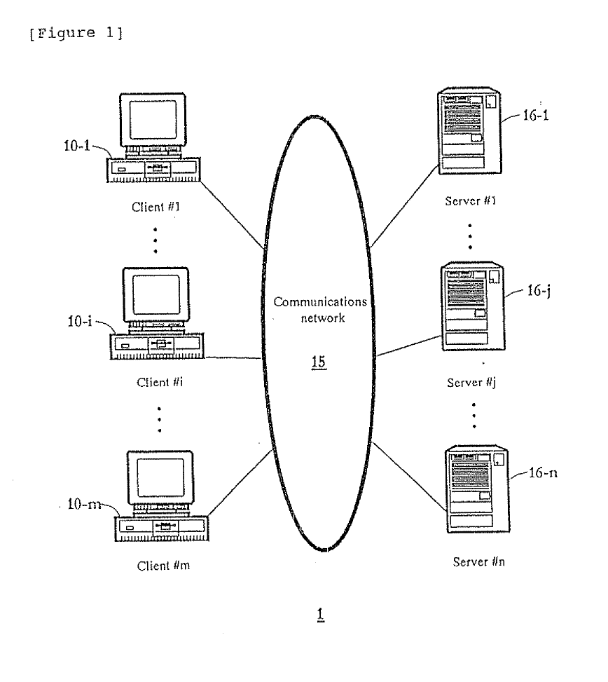

FIG. 1 illustrates the configuration of the data charging system 1 according to the present invention.

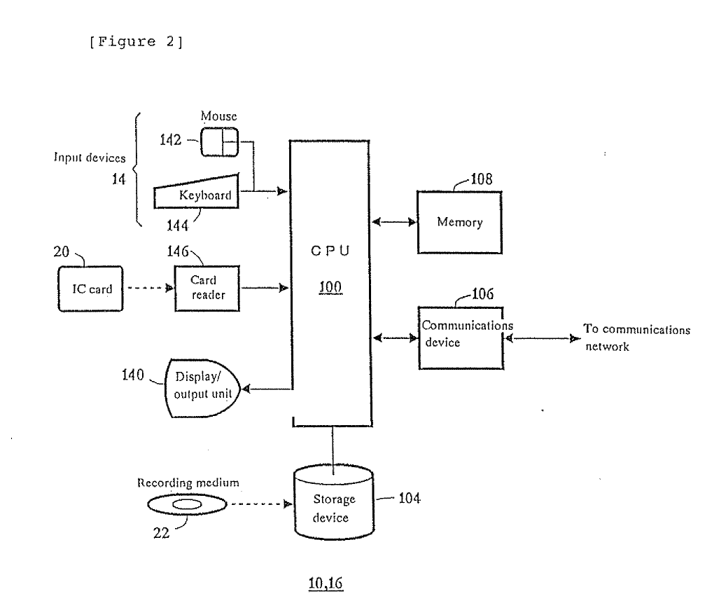

FIG. 2 illustrates the configuration of the client machines 10 and server machines 16 shown in FIG. 1.

As shown in FIG. 1, the data charging system 1 consists of, for example, m client machines (#1 to #i to #m) 10-1 to 10-i to 10-m and n server machines (#1 to #i to #n) 16-1 to 16-j to 16-n, connected through a communications network 14.

Hereafter, the client machines 10-1 to 10-i to 10-m and server machines 16-1 to 16-j to 16-n will be referred to collectively as the client machine 10 and the server machine 16, respectively, unless individual machines are addressed specifically.

As shown in FIG. 2, each of the client machine 10 and server machine 16 comprises a CPU 12; display/output unit 140 comprising a CRT display, printer, etc.; storage device 104; communications device 106; memory 108; and input device 14, which in turn comprises, for example, a mouse 142, keyboard 144, card reader 146, etc.

In short, both client machine 10 and server machine 16 have the configuration of a typical computer with data communications functions.

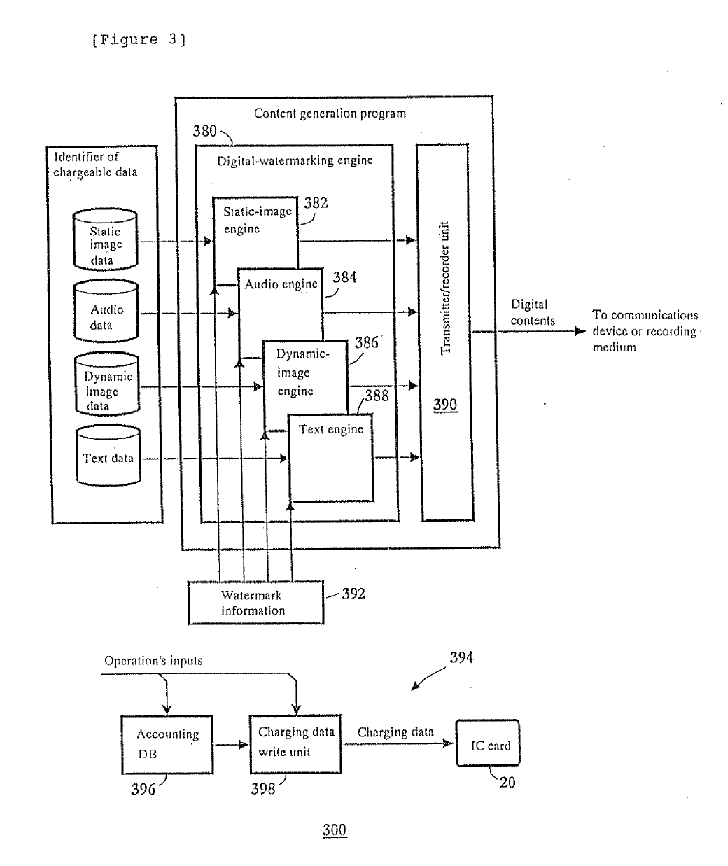

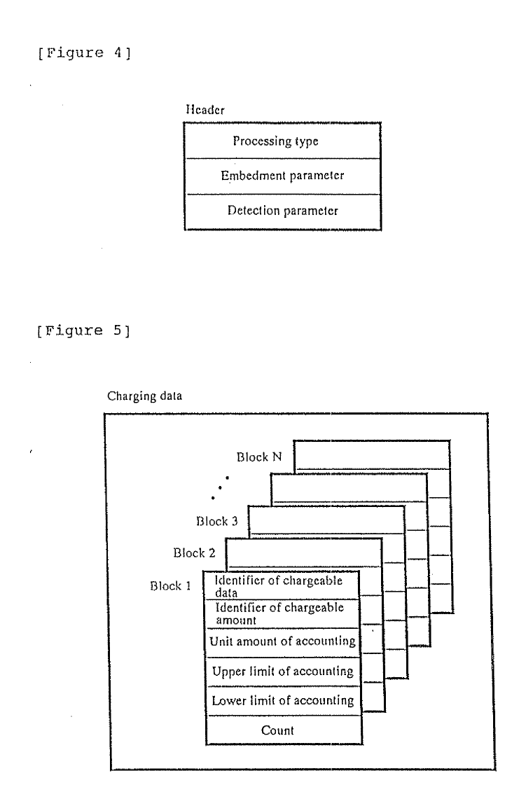

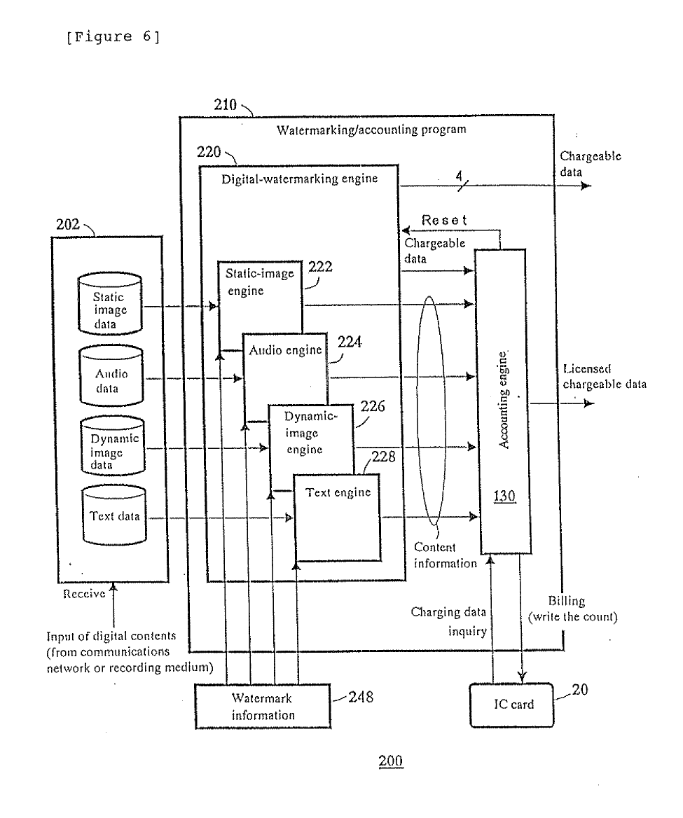

The client machine 10 and server machine 16 run different software: the server machine 16 runs a content generation program 300 (described later with reference to FIG. 3) while the client machine 10 runs a watermarking/accounting program 200 (described later with reference to FIG. 5)

In the data charging system 1 (FIG. 1), the server machine 16 generates contents with or without marking, which involves embedding digital watermarks in image data, various processing programs (data programs), or the like, and then server machine 16 delivers (supplies) the contents to the client machine 10 via the communications network 15 or by means for recording media 22 such as CD-ROM.

The server machine 16 contains nonvolatile memory such as flash memory, writes charging data according to payments into an IC card (also known as a smart card or the like) 20 equipped with terminals for reading from and writing into the nonvolatile memory externally, and provides the IC card to the user of the client machine 10 in the form of so-called electronic money.

Also in the data charging system 1 (FIG. 1), the client machine 10 separates data programs from the digital contents delivered by the server machine 16, embeds digital watermarks in the data programs if the latter does not contain digital watermarks yet, and provides the data programs to the user.

Or if the data programs are supposed to be embedded with digital watermarks, the client machine 10 provides each data program to the user only if a digital watermark is detected in it.

The client machine 10 separates a symbol or number unique to each data program or an identifier which simply indicates the type of the data program and then the client machine 10 provides it as recognition data for accounting.

The client machine 10 also reads, by means for a card reader 146, the charging data which was recorded from the server machine 16 to the IC card 20 and provided as described above in the form of so-called electronic money, runs an accounting process, and writes the resulting charging data (count) into the IC card 20.

For simplicity and clarification, the following illustrative example assumes that the data charging system 1 handles only images and similar data, that the unit of measure for accounting is data volume (pixel count or frame count), and that the recognition data simply represents the type of program, unless otherwise stated.

FIG. 3 shows the configuration of the content generation program 300 which runs on the server machine 16 of FIGS. 1 and 2.

The content generation program 300 is provided to the server machine 16, having been recorded on the recording medium 22 (FIG. 2), for example, and then loaded into memory 108.

As shown in FIG. 3, the content generation program 300 consists of a digital-watermarking engine 380, transmitter/recorder unit 390, watermark information holder 392, and charging data processor 394.

The digital-watermarking engine 380 comprises a static-image engine 382, audio engine 384, dynamic-image engine 386, and text engine 388, depending on the kinds of data to be included in the contents.

The charging data processor 394 comprises an accounting database (DB) 396 and charging data write unit 398.

FIG. 4 shows the watermark information added to contents by the content generation program 300 of FIGS. 1 and 2.

By means for the above-mentioned components, the content generation program 300 generates static image data, audio data, dynamic image data, and text data (these data correspond to the data programs described so far and are also referred to generically as “chargeable data”), which are recorded on the recording media 22 or provided by other communications nodes (other server machines 16, client machines 10, other computers not shown, etc.) through the communications network 15.

The content generation program 300 generates digital contents, which consist of chargeable data with or without a digital watermark embedded, identifier (recognition data) which recognizes the kind of chargeable data, and watermark information (FIG. 4) which varies depending on whether the chargeable data is embedded with a digital watermark.

As shown in FIG. 4, watermark information contains processing type data, embedment parameter data, and detection parameter data.

Of the watermark information, the processing type data is used to specify whether to embed digital watermarks in chargeable data or to separate charging data and recognition data from digital contents on the client machine 10.

In other words, if digital watermarks are not embedded in chargeable data when digital contents are generated, the content generation program 300 sets the processing type data in the watermark information indicating that an action be taken to embed digital watermarks in the chargeable data.

Conversely, if digital watermarks are embedded in chargeable data when digital contents are generated, the content generation program 300 sets the processing type data in the watermark information indicating that an action be taken to detect if digital watermarks are embedded in the chargeable data.

The embedment parameter data concerns the parameter used to embed digital watermarks in chargeable data on the client machine 10.

The detection parameter data concerns the parameter used on the client machine 10 to detect digital watermarks in chargeable data contained in digital contents and separate the recognition data embedded as the digital watermarks from the original chargeable data not embedded with digital watermarks.

FIG. 5 shows the charging data recorded on the IC card 20 of FIG. 1.

The content generation program 300 records the charging data shown in FIG. 5 on individual blocks of the IC card 20 if the user of the client machine 10 pays the prices for the use of chargeable data. The IC card 20 containing the charging data is given to the user who has paid prices and is inserted into the card reader 146 of the user's client machine 10.

As shown in FIG. 5, the charging data recorded on each block of the IC card 20 contains the identifier (recognition data) of a chargeable item (the same as chargeable data), identifier of a chargeable amount, unit amount of accounting (unit price data), upper and lower limits of accounting (accounting range data), and count (payment data).

Of the charging data, the identifier (recognition data) of a chargeable item, which is the same as the recognition data contained in digital contents, identifies the kind of chargeable data.

Of the identifier of a chargeable amount and unit amount of accounting (unit price data), the identifier of a chargeable amount represents the unit of usage of chargeable data, used for calculating the price of the chargeable data.

In the data charging system 1, for example, the usage of static image data, audio data and dynamic image data, and text data is measured in pixels, frames, and characters, respectively.

The unit amount of accounting (unit price data) represents the price (in terms of counts) that corresponds to certain units of chargeable data as measured by the identifier of the chargeable amount.

In other words, the usage of chargeable data in terms of the identifier of a chargeable amount multiplied by the price (count) represented by the unit amount of accounting gives the price (count) to be charged for the use of the chargeable data.

Of the upper and lower limits of accounting (accounting range data), the lower limit of accounting represents the minimum usage handled in accounting on the client machine 10.

In other words, on the client machine 10, no price is charged if the usage of chargeable data as measured in terms of the accounting unit is lower than the lower limit of accounting, and a price is charged only if the usage of chargeable data is equal to or higher than the lower limit of accounting.

On the other hand, the upper limit of accounting represents the upper limit of one-time usage handled in accounting on the client machine 10.

In other words, on the client machine 10, after the one-time usage of chargeable data as measured in terms of the accounting unit exceeds the upper limit of accounting, the price is not increased however much the usage may increase: the price which corresponds to the upper limit of accounting is used in accounting.

The count corresponds to the balance in the price or amount prepaid by the client machine 10.

More particularly, first the count that corresponds to the total amount prepaid by the user is written into the IC card 20, then each time the user uses the chargeable data represented by the recognition data of the given block, the balance reduced in accordance with the usage is written as a remaining count into the IC card 20 within the upper and lower limits of accounting.

The watermark information holder 392 holds watermark information for static images, audio, dynamic images, and text and outputs it to the static-image engine 382, audio engine 384, dynamic-image engine 386, and text engine 388, respectively.

In the digital-watermarking engine 380, the static-image engine 382 embeds a digital watermark, as required, in the static image data fed from outside as chargeable data, adds the watermark information for static images (FIG. 4) held in the watermark information holder 392 as well as recognition data to generate digital contents of static images, and outputs them to the transmitter/recorder unit 390.

The audio engine 384 embeds a digital watermark, as required, in the audio data fed from outside as chargeable data, adds the watermark information for audio (FIG. 4) held in the watermark information holder 392 as well as recognition data to generate digital contents of audio, and outputs them to the transmitter/recorder unit 390.

The dynamic-image engine 386 embeds a digital watermark, as required, in the dynamic image data fed from outside as chargeable data, adds the watermark information for dynamic images (FIG. 4) held in the watermark information holder 392 as well as recognition data to generate digital contents of dynamic images, and outputs them to the transmitter/recorder unit 390.

The text engine 388 embeds a digital watermark, as required, in the text data fed from outside as chargeable data, adds the watermark information for text (FIG. 4) held in the watermark information holder 392 as well as recognition data to generate digital contents of text, and outputs them to the transmitter/recorder unit 390.

The transmitter/recorder unit 390 delivers the digital contents input from the digital-watermarking engine 380, to each of the client machines 10 via the communications network 15 or on the recording medium 22.

The accounting database 396 stores the identifier of the chargeable item, identifier of the chargeable amount, unit amount of accounting, upper limit of accounting, and lower limit of accounting (FIG. 5) for specified items of the chargeable data delivered by the server machine 16.

The accounting database 396 also accepts the user's operation on input devices 14 of the server machine 16, including the inputs of information about the chargeable data for which prices have been paid by the user of the client machine 10, and outputs the identifier of the chargeable item, identifier of the chargeable amount, unit amount of accounting, upper limit of accounting, and lower limit of accounting for the specified items of chargeable data to the charging data write unit 398.

The charging data write unit 398 accepts the user's operation on input devices 14 of the server machine 16, including the specification of the count that corresponds to the payment made by the user of the client machine 10, and writes the specified count together with the data received from the accounting database 396 into the IC card 20 via the card reader 146 as charging data (FIG. 5).

The IC card 20 into which charging data has been written by the charging data write unit 398 is handed to the user of the client machine 10 who has paid the price and is inserted into the card reader 146 of the client machine 10.

FIG. 6 shows the configuration of the watermarking/accounting program 200 which runs on the client machine 10 of FIGS. 1 and 2.

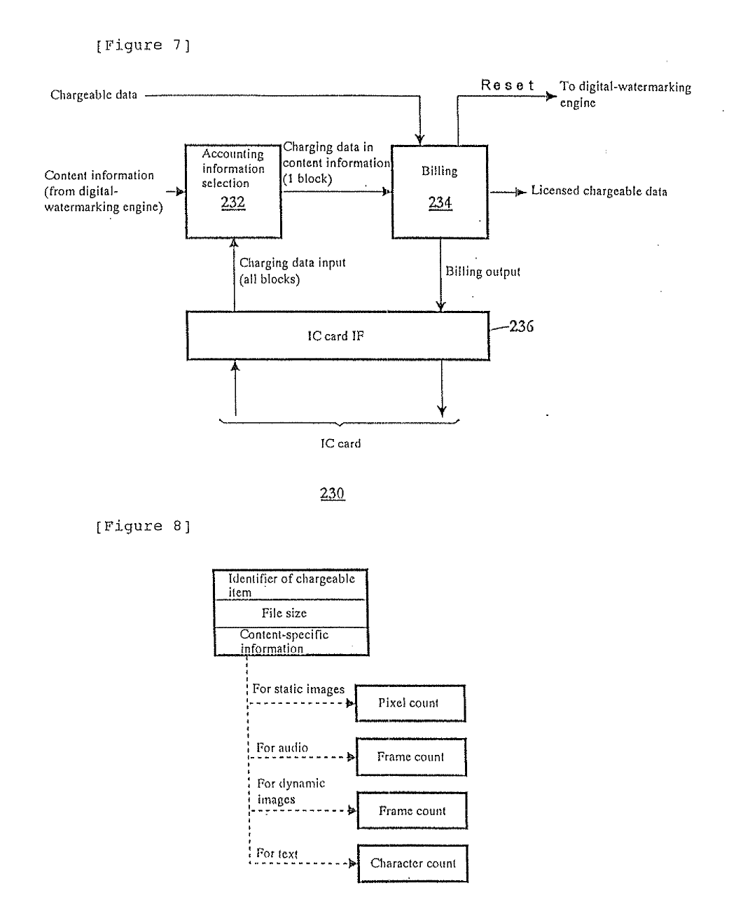

FIG. 7 shows the configuration of the accounting engine 230 shown in FIG. 6.

The watermarking/accounting program 200 is provided to the client machine 10, having been recorded on the recording medium 22, and is loaded into memory 108 (FIG. 2) for operation, as is the case with the content generation program 300.

As shown in FIG. 6, the watermarking/accounting program 200 consists of a digital-content receiving module 202, accounting module 210, and watermark information database.

The accounting module 210 includes a digital-watermarking engine 220 and accounting engine 230.

The digital-watermarking engine 220 comprises a static-image engine 222, audio engine 224, dynamic-image engine 226, and text engine 228.

The accounting engine 230 comprises an accounting information selector 232, billing processor 234, and IC card interface (IF) 236, as shown in FIG. 7.

By means for the above-mentioned components, the watermarking/accounting program 200 separates accounting information (FIG. 4) from the digital contents generated by the server machine 16, further separates chargeable data and recognition data from the digital contents by using the separated accounting information, and provides the chargeable data with a digital watermark embedded in it to the user of the client machine 10.

Also, the watermarking/accounting program 200 reads charging data (FIG. 5) from the IC card 20 inserted in the card reader 146 (FIG. 2) and charges prices for the use of chargeable data on a pay-per-use basis (according to the usage count, data volume, etc.) by using the charging data and the recognition data separated from the digital contents.

The digital-content receiving module 202 receives digital contents recorded on the recording media 22 or digital contents delivered from the server machine 16 via the communications network 15, identifies the kinds of the chargeable data (static image, audio, dynamic image, and text), and outputs the digital contents containing static image data, audio data, dynamic image data, and text data to the static-image engine 222, audio engine 224, dynamic-image engine 226, and text engine 228 of the digital-watermarking engine 220, respectively, according to the kind of the chargeable data.

The kinds of chargeable data contained in digital contents can be identified easily by checking the file formats or file name extensions of the chargeable-data files contained in the digital contents.

In the following illustrative example, data used to identify the kinds of chargeable data is treated as recognition data.

The watermark information holder 248 holds the detection parameter which corresponds to the detection parameter data of the watermark information (FIG. 4) contained in digital contents and the embedment parameter which corresponds to the embedment parameter data, and outputs the parameters to the static-image engine 222, audio engine 224, dynamic-image engine 226, or text engine 228 of the digital-watermarking engine 220, respectively, according to the kind of the chargeable data (static image, audio, dynamic image, or text).

In the static-image engine 222, audio engine 224, dynamic-image engine 226, or text engine 228 of the digital-watermarking engine 220, the detection parameter is used to detect digital watermarks in chargeable data and the embedment parameter is used to embed digital watermarks in chargeable data.

In the digital-watermarking engine 220, the static-image engine 222 receives digital contents containing chargeable static image data through the digital-content receiving module 202, acquires the parameter necessary for detection of digital watermarks from the watermark information holder 248 by using the detection data contained in the watermark information (FIG. 4) contained in the received digital contents, and separates recognition data and chargeable data (static image data) from the digital contents.

The static-image engine 222 outputs the separated static image data to the billing processor 234 (FIG. 7).

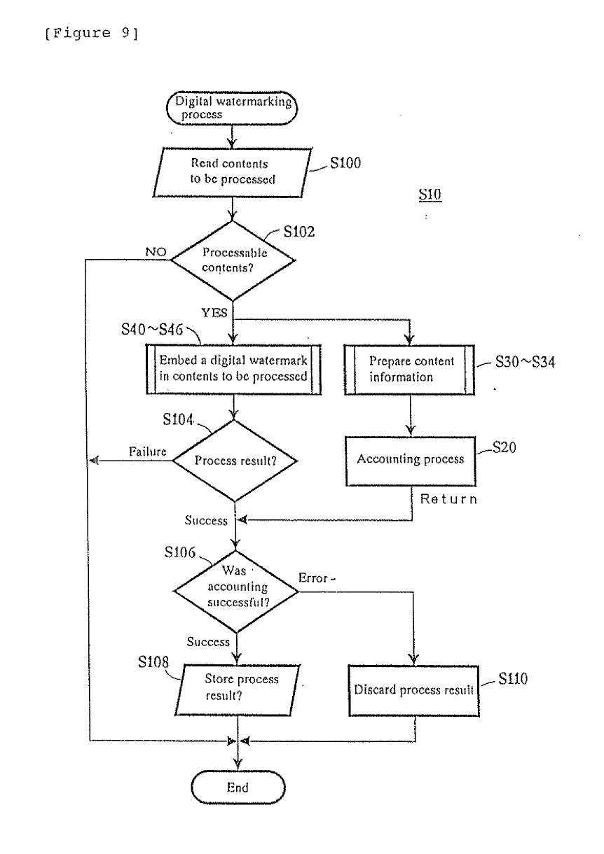

FIG. 8 shows the content information output by the digital-watermarking engine 220 of FIG. 6 to the accounting engine 230.

As shown in FIG. 8, the static-image engine 222 outputs the identifier (recognition data) and file size of the chargeable item (static image data) separated from digital contents together with content-specific information (pixel count) to the accounting engine 230 as content information.

The content-specific information, which varies with the kind of chargeable data as shown in FIG. 8, contains data about the unit of measure (which corresponds to the identifier of the chargeable amount in charging data (FIG. 5)) used for measuring the chargeable data as well as data about the amount (expressed in terms of this unit) of the chargeable data contained in digital contents.

The audio engine 224 (FIG. 6) receives digital contents containing chargeable audio data through the digital-content receiving module 202, acquires the parameter necessary for detection of digital watermarks from the watermark information holder 248 by using the detection parameter contained in the watermark information (FIG. 4) contained in the received digital contents, and separates recognition data and chargeable data (audio data) from the digital contents.

The audio engine 224 outputs the separated audio data to the billing processor 234 (FIG. 7).

As shown in FIG. 8, the audio engine 224 outputs the identifier (recognition data) and file size of the chargeable item separated from digital contents together with content-specific information (frame count) determined according to the kind (audio data) of chargeable data identified by the digital-content receiving module 202, to the accounting engine 230 as content information.

The dynamic-image engine 226 receives digital contents containing chargeable dynamic image data from an input device 210, acquires the parameter necessary for detection of digital watermarks from the watermark information holder 248 by using the detection parameter contained in the watermark information (FIG. 4) contained in the received digital contents, and separates recognition data and chargeable data (dynamic image data) from the digital contents.

The dynamic-image engine 226 outputs the separated dynamic image data to the billing processor 234 (FIG. 7).

As shown in FIG. 8, the dynamic-image engine 226 outputs the identifier (recognition data) and file size of the chargeable item separated from digital contents together with content-specific information (frame count) determined according to the kind (dynamic image data) of chargeable data identified by the digital-content receiving module 202, to the accounting engine 230 as content information.

The text engine 228 (FIG. 6) receives digital contents containing chargeable text data through the digital-content receiving module 202, acquires the parameter necessary for detection of digital watermarks from the watermark information holder 248 by using the detection parameter contained in the watermark information (FIG. 4) contained in the received digital contents, and separates recognition data and chargeable data (text data) from the digital contents.

The text engine 228 outputs the separated text data to the billing processor 234 (FIG. 7).

As shown in FIG. 8, the text engine 228 outputs the identifier (recognition data) and file size of the chargeable item separated from digital contents together with content-specific information (character count) determined according to the kind (text data) of chargeable data identified by the digital-content receiving module 202, to the accounting engine 230 as content information.

If the processing type in watermark information (FIG. 4) is embedment, the static-image engine 222, audio engine 224, dynamic-image engine 226, and text engine 228 receive the digital contents containing respective chargeable data through the digital-content receiving module 202, acquire the embedment parameter necessary for processing from the watermark information holder 248 by using the embedment parameter data contained in the received digital contents, embed a digital watermark in the chargeable data, and output the chargeable data to the billing processor 234 (FIG. 7) of the accounting engine 230 (FIG. 6).

If the processing type in watermark information (FIG. 4) is detection, the static-image engine 222, audio engine 224, dynamic-image engine 226, and text engine 228 receive the digital contents containing respective chargeable data through the digital-content receiving module 202, acquire the embedment parameter necessary for processing from the watermark information holder 248 by using the detection parameter data contained in the received digital contents, detect whether the chargeable data is embedded with a digital watermark, and output the chargeable data to the billing processor 234.

The accounting engine 230 runs an accounting process for pay-per-use charging for chargeable data: subtracts the usage count of chargeable data from the count contained in the charging data by using the content information (FIG. 8) supplied from the digital-watermarking engine 220 and charging data (FIG. 5) read out from the IC card 20 and writes the result into the IC card 20.

The IC card IF 236 reads charging data (FIG. 5) from the IC card 20 inserted in the card reader 146 and outputs it to the accounting information selector 232.

Also, the IC card IF 236 writes the billing output (count reduced as a result of billing) received from the billing processor 234 into the IC card 20.

The accounting information selector 232 compares the identifier (recognition data) of the chargeable item contained in the content information (FIG. 8) received from the digital-watermarking engine 220 and the identifier (recognition data) of the chargeable item contained in the charging data (FIG. 5) read out from each block of the IC card 20, reads the charging data from the block that contains the same identifier (recognition data) as the one contained in the content information, and outputs it together with the content information to the billing processor 234.

The billing processor 234 runs an accounting process, based on the charging data of the one specific block received from the accounting information selector 232 as well as on the content information, changes the count in the charging data, and writes the charging data into the appropriate block of the IC card 20 via the IC card IF 236.

The billing processor 234 permits the use of the chargeable data output by the digital-watermarking engine 220 only if the watermarking and accounting processes have been run properly.

With reference to FIGS. 9 to 18, a detailed description of the overall accounting process run by the watermarking/accounting program 200 will be provided below.

FIG. 9 is a flowchart showing the watermarking process and detection/removal process (digital-watermarking process: S10) performed by the digital-content receiving module 202 and digital-watermarking engine 220 of FIG. 6.

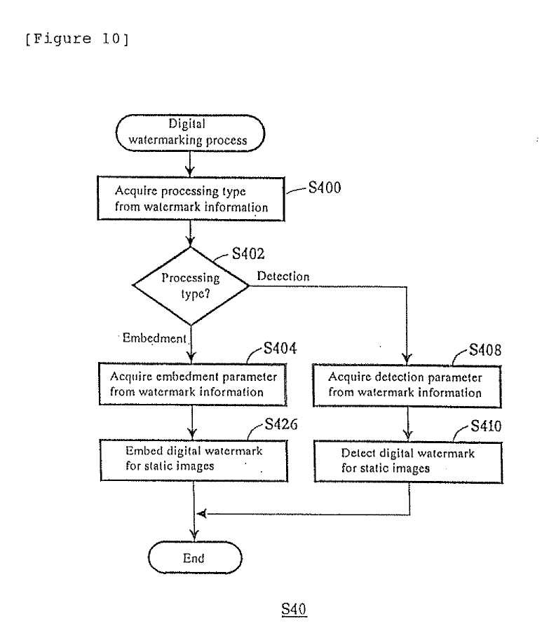

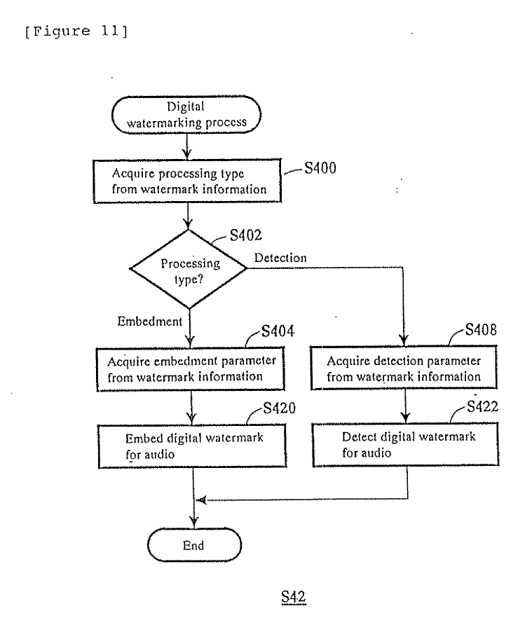

FIGS. 10 to 13 are flowcharts showing the watermarking processes (S40, S42, S44, and S46 shown in FIG. 9) of digital contents containing static image data, audio data, dynamic image data, and text data, respectively.

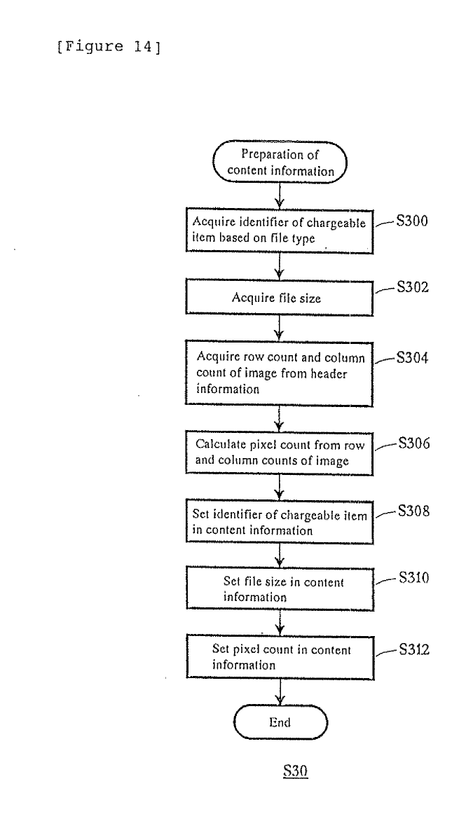

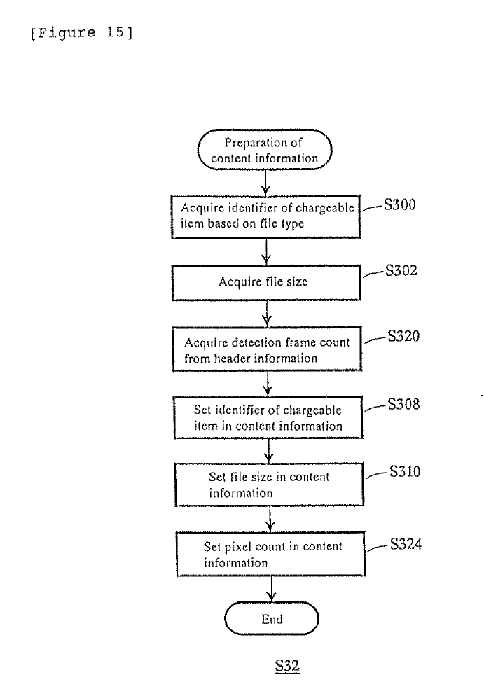

FIGS. 14 to 16 are flowcharts showing the processes (S30, S32, and S34 shown in FIG. 9) of generating content information (FIG. 8) from digital contents containing static image data, audio data or dynamic image data, and text data, respectively.

As shown in FIG. 9, in Step 100 (S100), the digital-content receiving module 202 (FIG. 6) receives the digital contents delivered from the client machine 10.

In Step 102 (S102), the digital-content receiving module 202 determines whether the received digital contents contain chargeable data that can be watermarked, i.e., in this embodiment, it determines whether the received digital contents contain static image data, audio data, dynamic image data, or text data, and if they do, the process advances to any of S40, S42, S44, or S46 (FIGS. 10 to 13) or any of S30, S32, or S34 (FIGS. 14 to 16) depending on the kind of data contained.

First, the watermarking process (S40 in FIGS. 9 and 10) in case digital contents contain static images will be described.

As shown in FIG. 10, the digital-content receiving module 202 outputs the digital contents to the static-image engine 222 of the digital-watermarking engine 220 in Step 400 (S400).

In Step 402 (S402), the static-image engine 222 separates static image data and watermark information (FIG. 4) from the digital contents and determines the processing type data from the separated watermark information. If the processing type data are embedment of a digital watermark, the process advances to S404. Otherwise, it goes to S408.

In Step 404 (S404), the static-image engine 222 extracts embedment parameter data from the watermark information and reads out the embedment parameter that corresponds to this embedment parameter data from the watermark information holder 248.

In Step 406 (S406), the static-image engine 222 embeds a digital watermark for static images in the static image data, and then advances to S104 (FIG. 9).

In Step 408 (S408), the static-image engine 222 extracts detection parameter data from the watermark information and reads out the detection parameter that corresponds to this detection parameter data from the watermark information holder 248.

In Step 410 (S410), the static-image engine 222 detects a digital watermark for static images in the static image data, and then advances to S104 (FIG. 9).

Next, the watermarking process (S42 in FIGS. 9 and 11) in case digital contents contain audio data will be described.

As shown in FIG. 11, the digital-content receiving module 202 outputs digital contents to the audio engine 224 of the digital-watermarking engine 220 in Step 400 (S400).

In Step 402 (S402), the audio engine 224 separates static image data and watermark information (FIG. 4) from the digital contents and determines the processing type data from the separated watermark information. If the processing type data are embedment of a digital watermark, the process advances to S404. Otherwise, it goes to S408.

In Step 404 (S404), the audio engine 224 extracts embedment parameter data from the watermark information and reads out the embedment parameter that corresponds to this embedment parameter data from the watermark information holder 248.

In Step 420 (S420), the audio engine 224 embeds a digital watermark for audio in the audio data, and then advances to S104 (FIG. 9).

In Step 408 (S408), the audio engine 224 extracts detection parameter data from the watermark information and reads out the detection parameter that corresponds to this detection parameter data from the watermark information holder 248.

In Step 422 (S422), the audio engine 224 detects a digital watermark for audio in the audio data, and then advances to S104 (FIG. 9).

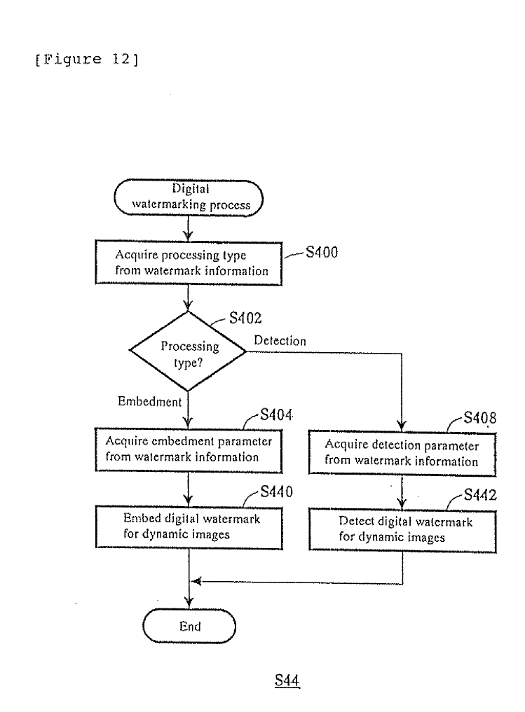

Now, the watermarking process (S44 in FIGS. 9 and 12) in case digital contents contain dynamic images will be described.

As shown in FIG. 12, the digital-content receiving module 202 outputs the digital contents to the dynamic-image engine 226 of the digital-watermarking engine 220 in Step 400 (S400).

In Step 402 (S402), the dynamic-image engine 226 separates static image data and watermark information (FIG. 4) from the digital contents and determines the processing type data from the separated watermark information. If the processing type data are embedment of a watermark, the process advances to S404. Otherwise, it goes to S408.

In Step 404 (S404), the dynamic-image engine 226 extracts embedment parameter data from the watermark information and reads out the embedment parameter that corresponds to this embedment parameter data from the watermark information holder 248.

In Step 440 (S440), the dynamic-image engine 226 embeds a digital watermark for dynamic images in the dynamic image data, and then advances to S104 (FIG. 9).

In Step 408 (S408), the dynamic-image engine 226 extracts detection parameter data from the watermark information and reads out the detection parameter that corresponds to this detection parameter data from the watermark information holder 248.

In Step 442 (S442), the dynamic-image engine 226 detects a digital watermark for dynamic images in the dynamic image data, and then advances to S104 (FIG. 9).

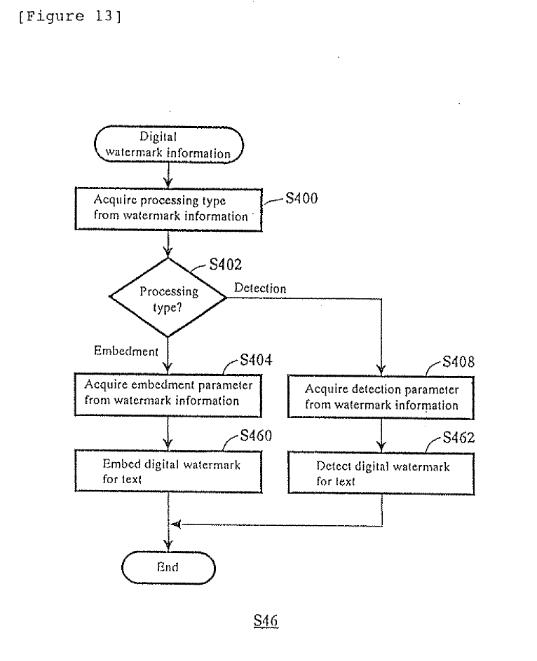

Now, the watermarking process (S46 in FIGS. 9 and 13) in case digital contents contain text data will be described.

As shown in FIG. 13, the digital-content receiving module 202 outputs the digital contents to the text engine 228 of the digital-watermarking engine 220 in Step 400 (S400).

In Step 402 (S402), the text engine 228 separates static image data and watermark information (FIG. 4) from the digital contents and determines the processing type data from the separated watermark information. If the processing type data are embedment of a watermark, the process advances to S404. Otherwise, it goes to S408.

In Step 404 (S404), the text engine 228 extracts embedment parameter data from the watermark information and reads out the embedment parameter that corresponds to this embedment parameter data from the watermark information holder 248.

In Step 460 (S460), the text engine 228 embeds a digital watermark for text in the text data, and then advances to S104 (FIG. 9).

In Step 408 (S408), the text engine 228 extracts detection parameter data from the watermark information and reads out the detection parameter that corresponds to this detection parameter data from the watermark information holder 248.

In Step 462 (S462), the text engine 228 detects a digital watermark for text in the text data, and then advances to S104 (FIG. 9).

Now, a description will be given of the process (S30 in FIGS. 9 and 14) of generating the content information shown in FIG. 8 from digital contents containing static image data.

As shown in FIG. 14, in Step 300 (S300), the static-image engine 222 of the digital-watermarking engine 220 (FIG. 6) acquires, as recognition data, for example, the file name extension of the chargeable data (static image data) separated from the digital contents or the data on the kind of the chargeable data attached separately to the digital contents.

In Step 302 (S302), the static-image engine 222 measures the file size (data volume) of the chargeable data (static image data).

In Step 304 (S304), the static-image engine 222 acquires the number of scan lines (number of rows) in the vertical direction and number of pixels (number of columns) in the horizontal direction, of the static image by, for example, reading the header information attached to the chargeable data (static image data) file.

In Step 306 (S306), the static-image engine 222 calculates the pixel count (number of pixels) of the static image data (chargeable data) by, for example, multiplying the row count (number of rows) and column count (number of columns) of the static image determined in S304.

In Step 308 (S308), the static-image engine 222 sets the recognition data acquired in S300 as the identifier of the chargeable item in the content information (FIG. 8).

In Step 310 (S310), the static-image engine 222 sets the file size acquired in S302 in the content information.

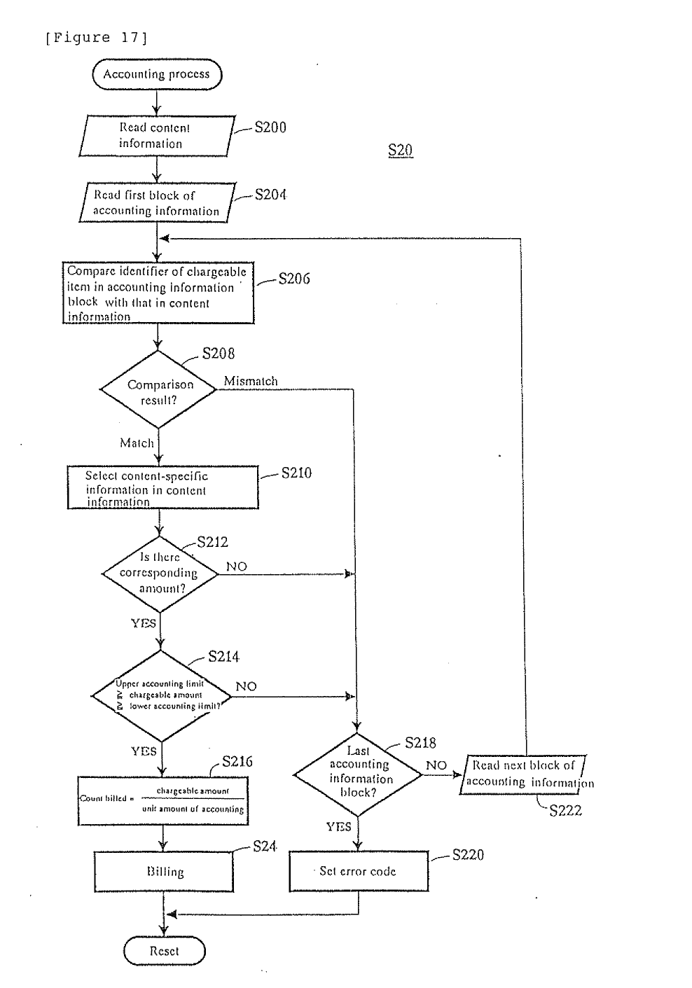

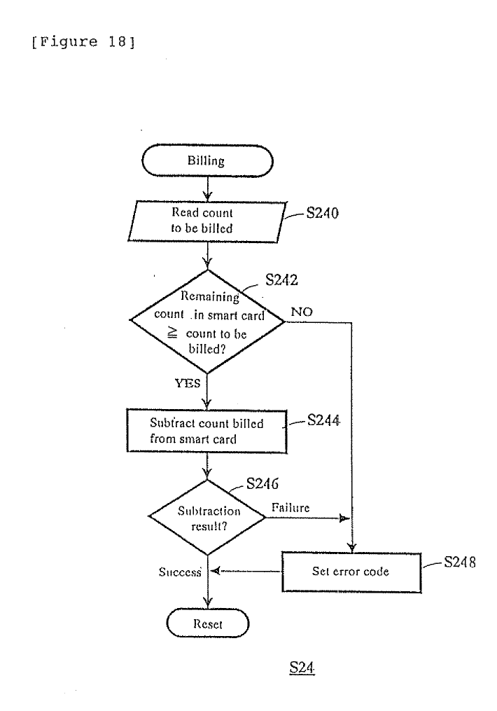

In Step 312 (S312), the static-image engine 222 sets the pixel count acquired in S306 in the content information to complete the content information for the static image. The static-image engine 222 outputs the completed content information to the accounting information selector 232 (FIG. 7) of the accounting engine 230 and advances to the accounting process S20 (FIGS. 9 and 17).

Now, a description will be given of the process (S32 in FIGS. 9 and 15) of generating the content information shown in FIG. 8 from digital contents containing audio or dynamic image data.

As shown in FIG. 15, in Step 300 (S300), the audio engine 224 or dynamic-image engine 226 of the digital-watermarking engine 220 (FIG. 6) acquires, as recognition data, for example, the file name extension of the chargeable data (audio or dynamic image data) or the data on the kind of the chargeable data attached separately to the digital contents.

In Step 302 (S302), the audio engine 224 or dynamic-image engine 226 measures the file size (data volume) of the chargeable data (audio or dynamic image data).

In Step 320 (S320), the audio engine 224 or dynamic-image engine 226 acquires the frame count of the audio or dynamic image data by, for example, reading the header information attached to the chargeable data (audio or dynamic image data) file.

In Step 308 (S308), the audio engine 224 or dynamic-image engine 226 sets the recognition data acquired in S300 as the identifier of the chargeable item in the content information (FIG. 8).

In Step 310 (S310), the audio engine 224 or dynamic-image engine 226 sets the file size acquired in S302 in the content information.

In Step 324 (S324), the audio engine 224 or dynamic-image engine 226 sets the frame count acquired in S320 in the content information to complete the content information for the audio or dynamic-image. The audio engine 224 or dynamic-image engine 226 outputs the completed content information to the accounting information selector 232 (FIG. 7) of the accounting engine 230 and advances to the accounting process S20 (FIGS. 9 and 17).

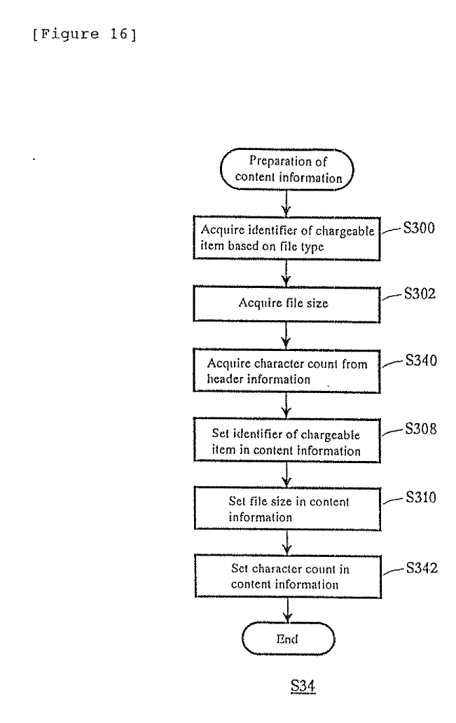

Now, a description will be given of the process (S34 in FIGS. 9 and 16) of generating the content information shown in FIG. 8 from digital contents containing text data.

As shown in FIG. 16, in Step 300 (S300), the text engine 228 of the digital-watermarking engine 220 (FIG. 6) acquires, as recognition data, for example, the file name extension of the chargeable data (text data) or the data on the kind of the chargeable data attached separately to the digital contents.

In Step 302 (S302), the text engine 228 measures the file size (data volume) of the chargeable data (text data).

In Step 340 (S340), the text engine 228 acquires the character count of the text data by, for example, reading the header information attached to the chargeable data (text data) file.

In Step 308 (S308), the text engine 228 sets the recognition data acquired in S300 as the identifier of the chargeable item in the content information (FIG. 8).

In Step 310 (S310), the text engine 228 sets the file size acquired in S302 in the content information.

In Step 342 (S342), the text engine 228 sets the character count acquired in S340 in the content information to complete the content information for the text. The text engine 228 outputs the completed content information to the accounting information selector 232 (FIG. 7) of the accounting engine 230 and advances to the accounting process S20 (FIGS. 9 and 17).

Now, the accounting process will be described with reference to FIGS. 17 and 18.

FIG. 17 is a flowchart of the accounting process (S20) shown in FIG. 9.

FIG. 18 is a flowchart of the billing process (S24) shown in FIG. 17.

As shown in FIG. 17, in Step 200 (S200), the accounting information selector 232 (FIG. 7) acquires the content information (FIG. 8) generated in any of S30 to S34 (FIGS. 14 to 16).

In Step 204 (S204), the accounting information selector 232 reads the first block of the charging data (FIG. 5) from the IC card 20 (FIGS. 2 and 6) via the IC card IF 236.

In Step 206 (S206), the accounting information selector 232 compares the recognition data (identifier of the chargeable item) contained in one block of the charging data (FIG. 4) read from IC card 20 in S204 or S222 with the recognition data in the content information (FIG. 8) received from the digital-watermarking engine 220.

In Step 208 (S208), the accounting information selector 232 determines whether the comparison in S206 resulted in a match. If it did, the selector advances to S210. Otherwise, it goes to S218.

In Step 210 (S210), the accounting information selector 232 acquires content-specific information from the content information which was found in S208 to contain a matching identifier.

In Step 212 (S212), the accounting information selector 232 acquires the identifier of the chargeable amount from the chargeable data which was found in S208 to contain a matching identifier, and compares it with the content-specific information acquired in S210. If the content-specific information and chargeable amount match, the accounting information selector 232 advances to S214. Otherwise, it goes to S218.

In Step 214 (S214), the accounting information selector 232 determines whether the amount (chargeable amount) of chargeable data in the digital contents indicated by the content-specific information in the content information is within the upper and lower limits of accounting contained in the charging data.

If the amount of chargeable data is within the upper and lower limits of accounting, the accounting information selector 232 advances to S216. Otherwise, it goes to S218.

In Step 216 (S216), the accounting information selector 232 outputs the charging data and content information which were found in S208 to contain matching identifiers to the billing processor 234 (FIG. 7).

The accounting information selector 232 divides the chargeable amount which is indicated by the content information by the unit amount of accounting in the charging data to determine the count to be deducted (count billed) from the count in the charging data of the given block as the price charged for the use of the chargeable data contained in the digital contents, and then advances to S24 (the billing process).

In Step 218 (S218), the accounting information selector 232 determines whether the last charging data loaded is the charging data in the last block of the IC card 20. If it is, the accounting information selector 232 advances to S220. Otherwise, it goes to S222.

In Step 220 (S220), the accounting information selector 232 sets an error code in the return value to the watermarking process S10, and then returns to S106 in FIG. 9.

The billing process S24 shown in FIG. 17 will be described below.

As shown in FIG. 18, in Step 240 (S240), the billing processor 234 reads out the count billed which was calculated in S216 of FIG. 17, from the accounting information selector 232.

In Step 242 (S242), the billing processor 234 determines whether the remaining count in the smart card (charging data) input in the accounting information selector 232 is equal to or smaller than the count billed. If it is, the billing processor 234 advances to S244. Otherwise, it goes to S248.

In Step 244 (S244), the billing processor 234 subtracts the count billed calculated in S216 from the count in the charging data via the IC card IF 236.

In Step 246 (S246), the billing processor 234 resets the error code in the return value to the watermarking process S10 and returns to S106 in FIG. 9 if the result of calculation in S244 is 0 or larger. Otherwise, it goes to S248.

In Step 248 (S248), the billing processor 234 sets an error code in the return value to the watermarking process S10, discards the result of the subtraction performed in S244, and then returns to S106 in FIG. 9.

Referring to FIG. 9 again.

In Step 104 (S104), the billing processor 234 determines if the watermarking process was run successfully by the digital-watermarking engine 220. If it was, the billing processor 234 advances to S106. Otherwise, it finishes processing.

In Step 106 (S106), if the return value from another process (S20 or S24 in FIGS. 17 and 18) is an error code, the billing processor 234 goes to S110 having determined that accounting was unsuccessful. Otherwise, it advances to S108 having determined that accounting was successful.

In Step 108 (S108), the billing processor 234 writes the result of subtraction obtained in S244 of the billing process S24 shown in FIG. 18 into the IC card 20 as the charging data of the block which was found to contain a matching identifier of chargeable data in S208 of the accounting process S20 shown in FIG. 17.

In the processes described above, the billing processor 234 reads out the chargeable data (static image data, audio data, dynamic image data, or text data) that has successfully gone through the watermarking process or detection process and accounting process from the digital-watermarking engine 220.

Furthermore, the billing processor 234 stores the read chargeable data in memory 108, and then records it on the recording medium 22 via the storage device 104 or displays it on the display/output unit 140 for use by the user.

In Step 110 (S110), the billing processor 234 controls the digital-watermarking engine 220 by activating the reset signal to discard the chargeable data obtained in the watermarking process (S40 to S46 in FIGS. 10 to 13).

The overall operation of the data charging system I will be described below with reference to figures.

On the server machine 16 (FIGS. 1 and 2), the content generation program 300 (FIG. 3) embeds watermarks in chargeable data such as static image data, audio data, dynamic image data, and text data and generates digital contents which contain the chargeable data embedded with the watermarks, recognition data indicating the kinds of the chargeable data, and watermark information (FIG. 4) for the case where watermarks are embedded in chargeable data.

Or the content generation program 300 does not embed watermarks in chargeable data and generates digital contents which contain the chargeable data, recognition data, and watermark information (FIG. 4) for the case where watermarks are not embedded in chargeable data.

The digital contents generated by the content generation program 300 are supplied to the client machine 10 through the recording medium 22, communications network 15, etc.

If the user of the client machine 10 has paid the prices for chargeable data, the content generation program 300 records the charging data (FIG. 5) in the appropriate blocks of the IC card 20. The IC card 20 with charging data recorded is given to the user who has paid the prices and is inserted into the card reader 146 of this user's client machine 10.

On the client machine 10 (FIGS. 1 and 2), the digital-content receiving module 202 (FIG. 6) receives the digital contents supplied from the server machine 16 and outputs digital contents containing static image data, audio data, dynamic image data, and text data to the static-image engine 222, audio engine 224, dynamic-image engine 226, and text engine 228 of the digital-watermarking engine 220, respectively.

In the digital-watermarking engine 220, the static-image engine 222, audio engine 224, dynamic-image engine 226, and text engine 228 receive the digital contents received from the digital-content receiving module 202, obtain the parameter necessary for detection of digital watermarks from the watermark information holder 248 by using the detection data contained in the watermark information (FIG. 4) contained in the received digital contents, separate recognition data and chargeable data from the digital contents, and output separated static image data to the billing processor 234 (FIG. 7).

The static-image engine 222, audio engine 224, dynamic-image engine 226, and text engine 228 also output the recognition data of chargeable data, the file size of the separated chargeable data, and content-specific information as content information (FIG. 8) to the accounting engine 230.

Further, the static-image engine 222, audio engine 224, dynamic-image engine 226, and text engine 228 embed or detect a digital watermark in the chargeable data according to the processing type indicated by the watermark information (FIG. 4), as shown in FIGS. 9 to 13

As shown in FIG. 17, the accounting information selector 232 (FIG. 7) of the accounting engine 230 (FIG. 6) compares the identifier (recognition data) of chargeable data contained in content information (FIG. 8) with that contained in charging data (FIG. 5) and outputs any matching content information and charging data to the billing processor 234.

The billing processor 234 runs an accounting process as shown in FIG. 18 based on the charging data and content information supplied from the accounting information selector 232, changes the count in the charging data, writes the charging data into the appropriate block of the IC card 20 via the IC card IF 236, and then provides the chargeable data output by the digital-watermarking engine 220 to the user only if the watermarking process and billing process have been successful.

Instead of recording different count data on each block, count data common to all the blocks may be recorded on the IC card 20 and shared among the accounting processes of different chargeable data.

As described above, the data charging system, content generator, data charging apparatus, and data charging method according to the present invention make it possible to charge the user for his/her use of digital contents in an easy and reliable manner by the use of a smart card.

Also, the data charging system, content generator, data charging apparatus, and data charging method according to the present invention make it possible to charge the user for his/her use of digital contents on a pay-per-use basis.

Furthermore, the data charging system, content generator, data charging apparatus, and data charging method according to the present invention make it possible to charge the user for his/her use of digital contents in an easy and reliable manner while preventing unauthorized use of digital contents by means for digital watermarking or the like.

While the invention has been particularly shown and described with respect to preferred embodiments thereof, it will be understood by those skilled in the art that the foregoing and other changes in form and details may be made therein without departing form the spirit and scope of the invention.

1. A content generator on a server machine for embedding digital watermarks in object data of a specific type and generating contents in a data charging system which records, on an IC card recording medium, charging data used for paying for object data contained in said contents and recognition data used for identifying the type of object data in said contents, and said IC card being used by a client machine to charge dynamically only for the use of the object data received by the client machine and embedded with said digital watermarks, based on the specific type of data said object data is, as determined by using said recognition data, and by using said charging data and said recognition data which have been recorded in said recording medium.
